(19) United States
(12) Patent Application Publication
(10) Pub. No.: US 2014/0262625 A1
(43) Pub. Date: Sep. 18, 2014

(54) MOVABLE LOAD BACKREST FOR A LIFT TRUCK

(71) Applicant: Geoffrey R. Sharp, Visalia, CA (US)

(72) Inventor: Geoffrey R. Sharp, Visalia, CA (US)

(21) Appl. No.: 13/840,254

(22) Filed: Mar. 15, 2013

(51) Int. Cl. B66F 9/075

(52) U.S. Cl. CPC B66F 9/075
USPC 187/222

(57) ABSTRACT

A movable load backrest for a lift truck. The movable load backrest can include at least one impact portion, and at least one mounting structure coupled to the at least one impact portion and attachable to the lift truck, wherein, when the movable load backrest is coupled to the lift truck, the distance between the at least one impact portion and the lift truck is variable.

### BACKGROUND

Lift trucks, also known as forklifts, are commonly used in warehousing, storage, and similar applications to transport packaged materials between locations, and to raise and stack packaged materials for storage. To facilitate transporting and lifting the materials, the materials are loaded on top of a pallet. Commonly used pallets are constructed from wood and have a bottom deck and a top deck coupled to a plurality of parallel stringers disposed therebetween, with openings provided between the stringers. The forklift inserts a pair of movable forks into the openings. Once the forks are disposed within the openings, the forklift can lift and transport the pallet and the load thereon.

The forks of a lift truck are part of a carriage assembly, which is in turn coupled to a mast of the lift truck. The carriage assembly moves vertically along the mast, allowing the pallet and the load thereon to be moved to a desired height. The carriage assemblies of certain lift trucks can be configured to allow lateral movement of the forks, so as to allow the forks to be adapted to pallets of varying width. Additionally, some carriage assemblies may be configured for movement in the longitudinal direction, allowing the forks to be positioned forwardly from the body of the lift truck. Finally, certain forklifts are provided with a “single-double” fork configuration, which allows the forklift to engage both single-width pallets, double-width pallets as well as multiple single-width pallets by including at least four forks and adjusting the lateral distance between the forks.

The vertical shanks of the forks and the front face of the carriage can supports the load when it is tilted rearwards, upwards, or elevated, or when the lift truck accelerates. For loads having greater heights, lift trucks can also include a load backrest coupled to, and movable with the carriage assembly. The load backrest is similar in appearance to a rack; e.g., a rectangular, or similarly-shaped frame having a plurality of spaced narrow bars extending within the frame. Gaps between the bars provide greater operator visibility. The load backrest is typically bolted or welded to the carriage assembly, and is positioned above the carriage so as to provide additional support for the load. The backrest allows for support of larger loads, preventing the load from shifting when the carriage assembly tilted rearward, upward, or elevated, or when the lift truck accelerates.

During operations, lift trucks can impact the pallet load with the vertical portions of the forks as well as with the load backrest. The force of such impacts may be applied to the pallet load if the load is overhanging the pallet. Furthermore, the rack-like configuration of typical load backrests results in the impact force being concentrated in the areas that are impacted by the narrow bars of the load backrest. Consequently, individuals and businesses can suffer significant losses due to product damage, as well as due to the labor involved in replacing damaged products.

### SUMMARY

According to at least one exemplary embodiment, a movable load backrest for a lift truck is disclosed. The movable load backrest can include at least one impact portion, and at least one mounting structure coupled to the at least one impact portion and attachable to the lift truck, wherein, when the movable load backrest is coupled to the lift truck, the distance between the at least one impact portion and the lift truck is variable.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1a is a perspective view of a first exemplary embodiment of a movable load backrest.

FIG. 1b is a front view of a first exemplary embodiment of a movable load backrest.

FIG. 1c is a side view of a first exemplary embodiment of a movable load backrest.

FIG. 2a shows an exemplary embodiment of a mounting structure for a movable load backrest, in an extended position.

FIG. 2b shows an exemplary embodiment of a mounting structure for a movable load backrest, in a compressed position.

FIG. 3a shows another exemplary embodiment of a mounting structure for a movable load backrest, in an extended position.

FIG. 3b shows another exemplary embodiment of a mounting structure for a movable load backrest, in a compressed position.

FIG. 4 shows a first exemplary embodiment of a movable load backrest coupled to a lift truck.

FIG. 5 is a perspective view of a second exemplary embodiment of a movable load backrest.

FIG. 6a is a side view of a second exemplary embodiment of a movable load backrest.

FIG. 6b is a side view of an exemplary rail for a movable load backrest.

FIG. 6c shows another exemplary embodiment of a mounting structure for a movable load backrest, configured for fixed coupling.

FIG. 6d shows the embodiment of the mounting structure of FIG. 6c, configured for slidable coupling.

FIG. 7a is a partial view of an exemplary coupling between a mounting structure and a fork of a forklift.

FIG. 7b is a top view of the second exemplary embodiment of a movable load backrest in a compact configuration.

FIG. 7c is a top view of the second exemplary embodiment of a movable load backrest in an extended configuration.

FIGS. 8a-8b show the second exemplary embodiment of a movable load backrest coupled to a single-double lift truck.

FIG. 9 shows a third exemplary embodiment of a movable load backrest.

FIG. 10a is a side view of exemplary embodiment of a mounting structure for the movable load backrest of FIG. 9, in an extended position.

FIG. 10b is a side view of exemplary embodiment of a mounting structure for the movable load backrest of FIG. 9, in a compressed position.

FIG. 10c is a front view of exemplary embodiment of a mounting structure for the movable load backrest of FIG. 9.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

FIG. 4 shows an exemplary embodiment of a movable load backrest 100 attached to the carriage assembly 12 of a lift truck 10. The carriage assembly 12 can include an upper carriage bar 14 and a lower carriage bar 16. The carriage assembly 12 can further include a pair of forks 20, 22, which may be coupled to carriage bars 14, 16 in any known manner. Carriage assembly 12 can be vertically adjustable along the height of the mast 18 of lift truck 10, while forks 20, 22 can be fixed, or can be laterally adjustable with respect to each other and to carriage assembly 12. Carriage assembly 12 can also be longitudinally adjustable with respect to the body of the lift truck 10. A fixed load backrest 24 may be coupled to carriage assembly 12 in any known manner. The fixed load backrest 24 can further be movable with carriage assembly 12 while remaining in a fixed position relative to the carriage assembly 12. The movable load backrest 100 is shown in FIG. 4 as being coupled to fixed load backrest 24, for example to a upper horizontal member of the load backrest 24. However, load backrest 100 may be coupled in any manner to any portion of the carriage assembly 12 that enables load backrest 100 to function as described herein.

FIGS. 1a-1c show an exemplary embodiment of a movable load backrest 100. The backrest 100 can include an impact portion 102. The impact portion 102 may have any desired shape and dimensions that enable load backrest 100 to function as described herein. In the illustrated exemplary embodiment, impact portion 102 can have a substantially rectangular, horizontally elongated shape. The impact portion 102 can further include a frame 104 surrounding an aperture 106.

Frame 104 may be constructed in any known manner and made from any desired material, for example metals, impact-resistant plastics, and so forth. In some exemplary embodiment, frame 104 may include a pair of horizontal flanges 110 and a pair of vertical flanges 112 extending rearwardly from a rear face of frame 104. Such an embodiment of frame 104 may be formed, for example, by disposing a pair of vertical L-beams to a pair of horizontal L-beams, and coupling the vertical and horizontal L-beams to each other. This can allow for a simple and cost-effective construction of frame 104.

Coupled to frame 104 and disposed over aperture 106 may be a planar transparent covering 108. The transparent covering 108 may be made from any material that allows load backrest 100 to function as described herein, for example from an impact-resistant, transparent polymer or the like. In some exemplary embodiments, the transparent covering 108 may further be coupled to a front face of frame 104, and disposed over a portion thereof. Furthermore, transparent covering 108 may be coupled to frame 104 by any known manner, for example fasteners, adhesives, and so forth.

The movable load backrest 100 can further include a plurality of variable-length, spring-dampened mounting structures 130. A plurality of apertures 118 may be defined in the lower horizontal portion of frame 104, for coupling the mounting structures 130 to impact portion 102. Each mounting structure 130 can be further be coupleable to a member of the carriage assembly 12 of a lift truck 10, to a load backrest 24 of the lift truck 10.

FIGS. 2a-2b show a cross section of an exemplary embodiment of a mounting structure 230 for a movable load backrest 100. Mounting structure 230 can include a sleeve 232 enclosing a channel 234. Sleeve 232 can have an open end 236 and a substantially closed end 238, with the closed end 238 having a bore 240 defined therethrough. An insert 242 can be axially slidable within channel 234. The insert 242 may likewise enclose a channel 244, and may have an open end 246 and a closed end 248, the closed end 248 having a bore 250 defined therethrough. Insert 242 may be positioned within sleeve 232 such that closed ends 238, 248 are positioned opposite each other, and channels 234, 244 are in communication with each other.

A resilient member 252, for example a coil spring, may be disposed within channels 234, 244. Resilient member 252 can engage both sleeve 232 and insert 242 such that when insert 242 is slid into sleeve 232, the resilient member 252 is compressed.

A guide bolt 254 can be slidably received through bore 240 of sleeve 232, through channels 234, 244, and through bore 250 of insert 242. Guide bolt 254 can include a head 256 and a fully or partially-threaded stem 258. Head 256 can have a diameter that is larger than the diameter of an aperture 118 of frame 104, while the diameter of stem 258 may be less than that of an aperture 118. A mounting nut 260 can threadably engage stem 258 so as to clamp frame 104 between head 256 and mounting nut 260, thereby coupling impact portion 102 to guide bolt 254. The mounting nut 260 may be positioned externally to insert 242 and between closed end 248 of insert 242 and frame 104.

At least one adjustment nut 262 can threadably engage stem 258 of guide bolt 254. The adjustment nut 262 can be positioned external to sleeve 232 and proximate closed end 238 of sleeve 232. The user can adjust the position of adjustment nut 262 along stem 258 so as to set a maximum extension limit for mounting structure 230.

FIGS. 3a-3b show another exemplary embodiment of a mounting structure 330 for a movable load backrest 100. The structure and functionality of mounting structure 330 shown in FIGS. 3a-3b can be substantially similar to those of the embodiment of mounting structure 230 shown in FIGS. 2a-2b, except for the features described below. Similar features are indicated in FIGS. 3a-3b by similar reference numerals, except with a hundreds digit of 3.

In the embodiment of mounting structure 330, guide bolt 354 can be disposed external to sleeve 332 and insert 342. A flange 364 can be coupled to and extend laterally from sleeve 332. A bore 366 can extend through flange 364, and guide bolt 354 can be received within bore 366. Guide bolt 354 can further extend through an aperture 118 of frame 104, with mounting nut 360 abutting frame 104. The adjustment nut 362 can be positioned so as to abut flange 364 at the desired maximum extension limit for mounting structure 330. Insert 242 may be coupled to frame 104 by way of a mounting bolt 368 received through bore 350 of insert 342 and a second aperture 118 of frame 104. Mounting bolt 368 may be held in place by a second mounting nut 370.

Coupling between the mounting structures and the forks of the lift truck may be accomplished by any desired manner. In one exemplary embodiment, as shown in FIG. 4, movable load backrest 100 may be coupled to a fixed load backrest 24 of a lift truck 10. This may be accomplished in any manner, for example by clamps, fasteners, or the like. In one exemplary embodiment, mounting structures 130 may be fixedly coupled, for example by welding, by fasteners, or the like, to an L-beam extending between the mounting structures and parallel to impact surface 102. The L-beam can then be coupled to the upper horizontal bar of the fixed load backrest 24, for example by clamping or by other fasteners. Any known manner of coupling mounting structures 130 to a fixed load backrest 24 or to another fixed portion of the carriage assembly 12 may be contemplated and provided as desired.

In operation, the movable load backrest 100 can be coupled to a fixed load backrest 24 of a lift truck 10. The transparent covering 108 can allow the operator to have an unobstructed view through the movable load backrest 100. When a load is picked up by the lift truck, movable load backrest 100 can provide a large, movable, and spring-dampened surface for contacting the load, thereby mitigating any damage from impact between the load and the load backrest 100. The movement of movable load backrest 100 can be substantially on the front-rear axis with respect to the lift truck, or may be oblique if the load backrest 100 is unevenly impacted by the load.

FIGS. 5-8b show another exemplary embodiment of a movable load backrest 500. The embodiment of movable load backrest 500 can be adapted for attachment to a single-double lift truck. As shown in FIGS. 8a-8b, a single-double lift truck 50 can have a first pair of forks 52 and a second pair of forks 58. The first pair of L-shaped forks 52 can include an outer fork 54 and an inner fork 56. Similarly, the second pair of L-shaped forks 58 can include an outer fork 60 and an inner fork 62. Typically, forks 52, 58 can be a part of a carriage assembly 64. Carriage assembly 64 can be vertically adjustable, while each of forks 22, 24, 28, 30 can be laterally adjustable with respect to each other and to carriage assembly 64.

Load backrest 500 can include a first impact portion 502 and a second impact portion 504. The impact portions 502, 504 may have any desired shape and dimensions that enable load backrest 500 to function as described herein. In the illustrated exemplary embodiment, impact portions 502, 504 can have a substantially rectangular, horizontally elongated, and planar shape. Each impact portion 502, 504 may be transparent, and may be made from any material that allows load backrest 100 to function as described herein, for example from an impact-resistant, transparent polymer or the like.

Each impact portion 502/504 can have an upper rail 506 coupled proximate the top of the impact portion and extending horizontally, and a lower rail 508 coupled proximate the bottom of the impact portion and extending substantially parallel to the upper rail. The rails may be coupled to the impact portions by any known manner, for example fasteners, adhesives and so forth.

As shown in FIGS. 6a-6b, each of the rails can have a C-shaped cross section. The vertical portion 560 of each rail can be coupled to impact portion 502/504, while the horizontal portions 562 can have a plurality of apertures 563 defined therein. A pair of flanges 566 can extend towards each other from horizontal portions 562, defining a gap 568 therebetween. A channel 570 can thus be enclosed by each rail 506/508.

The height of second impact portion 504 may be less than the vertical span between upper rail 506 and lower rail 508 of first impact portion 502. This can allow second impact portion 504 to be disposed rearwardly of and proximate to first impact portion 502.

As shown in FIGS. 6a and 7b, a pair of variable-length, spring-dampened mounting structures 530a, 530b may be coupled to each rail 506, 508. Mounting structure 530a may be fixedly coupled to rail 506/508, while mounting structure 530b may be slidably coupled to rail 506/508. The structure and functionality of mounting structures 530a, 530b can be substantially similar to those of the embodiment of mounting structure 330 shown in FIGS. 3a-3b, except for the features described below. Similar features are indicated by similar reference numerals, except with a hundreds digit of 5.

In the embodiment of mounting structure 530a/530b, guide bolt 554 can be disposed externally to sleeve 532 and insert 542. A first flange 564 can be coupled to and extend from sleeve 532, and a second flange 572 can be coupled to and extend from insert 542. Bores 566 can extend through flanges 564, 572, and guide bolt 554 can be received within bores 566. Mounting nut 560 can abut second flange 572, while adjustment nut 562 can be positioned so as to abut first flange 564 at the desired maximum extension limit for mounting structure 530. In other exemplary embodiments, a chain may be coupled to flanges 564, 572, the chain having a length corresponding to the desired maximum extension limit for mounting structure 530.

Coupled to the closed end 548 of insert 542 may be a coupling structure 576. In mounting structure 530a, the coupling structure 576 may be adapted for fixed coupling with rail 506/508. In mounting structure 530b, the coupling structure 576 may be adapted for slidable coupling with rail 506/508.

As an exemplary embodiment of mounting structure 530a is shown in FIG. 6c. In mounting structure 530a, the coupling structure 576 can include a hollow sleeve 578 through which a bolt 580 and nut 582 are received. Bolt 580 can pass through sleeve 578, as well as through a pair of vertically opposed apertures 563 of rails 506/508, and can be fixed in position by nut 582. An exemplary embodiment, of mounting structure 530b is shown in FIG. 6d. In mounting structure 530b, the coupling structure 576 can include a sleeve 578 through which an axle 584 can be received. A pair of wheels 586 can be coupled to the opposing ends of axle 584, thereby creating a bearing arrangement that can engage the inner surfaces of rail 506/508, thereby providing a slidable coupling between mounting structure 530b and the rail. However, it should be appreciated that any fixed and slidable coupling structures that allow backrest 500 to function as described herein may be contemplated and provided as desired.

Coupling between load backrest 500 and a single-double lift truck 50 may be achieved as follows. As shown in FIGS. 7a-7c, the first impact portion 502 may be coupled to the first pair of forks 52, while the second impact portion 504 may be coupled to the second pair of forks 58. Furthermore, for the first impact portion 502, fixed mounting structures 530a may be coupled to outer fork 54, while slidable mounting structures 530b may be coupled to inner fork 56. Similarly, for the second impact portion 504, fixed mounting structures 530a may be coupled to outer fork 60, while slidable mounting structures 530b may be coupled to inner fork 62.

Coupling between the mounting structures and the forks of the lift truck may be accomplished by any desired manner. In an exemplary embodiment, as shown in FIG. 7a, each mounting structure 530 may be provided with a flange 580 extending laterally therefrom. The flange 580 may be provided with a plurality of apertures, with each aperture receiving a bolt 582 therethrough. Flange 580 may be positioned forwardly of a vertical portion of a fork, while a clamping plate 584 having a corresponding number of apertures may be disposed rearwardly of the vertical portion of the fork. Bolts 582 may pass through the corresponding apertures of the clamping plate 584, and nuts 586 may be tightened on bolts 582 so as to secure the vertical portion of the fork between flange 580 and clamping plate 584.

In operation, can be attached to the forks of a single-double lift truck, substantially as described above. When the lift truck 50 is in a single pallet configuration, as shown in FIGS. 7b and 8a, the inner and outer forks 56, 54 of the first pair of forks 52 can be disposed substantially adjacent each other, and the inner and outer forks 62, 60 of the second pair of forks 58 can be likewise disposed substantially adjacent each other. Consequently, the second impact plate 554 can be disposed rearwardly of first impact plate 552, providing a movable and spring-dampened impact surface for high loads carried by the lift truck, thereby lessening damage to loads contacting the impact plate.

To accommodate objects of greater widths, such as a double-width pallet, the forklift can laterally displace the forks so as to increase the distance between the forks 54, 56, 60, 62. As the outer fork 54 is moved outwardly from inner fork 56, the fixed mounting structures 530a coupled to outer fork 54 facilitate the outward movement of first impact plate 502, while rails 506, 508 translate with respect to slidable mounting structures 530b, which are coupled to inner fork 56. Similarly, as the outer fork 60 is moved outwardly from inner fork 62, the fixed mounting structures 530a coupled to outer fork 60 facilitate the outward movement of second impact plate 504, while rails 506, 508 translate with respect to slidable mounting structures 530b, which are coupled to inner fork 62. The load backrest 500 can then assume an expanded configuration, as shown in FIGS. 7c and 8b, providing a pair of movable and spring-dampened impact surfaces for high loads carried by the lift truck, thereby lessening damage to loads contacting the impact plate. The movement of portions 502, 504 of movable load backrest 500 can be substantially on the front-rear axis with respect to the lift truck, or may be oblique if an impact portion 502/504 is unevenly impacted by the load.

FIG. 9 shows another exemplary embodiment of a movable load backrest 900. Load backrest 900 can have the form of a typical fixed load backrest. The load backrest 900 can include a pair of posts 902, a pair of horizontal bars 904 coupled to and extending between the posts, and a plurality of vertical bars 906 coupled to and extending between the horizontal bars. Horizontal bars 904 and vertical bars 906 can form an impact portion of the movable load backrest. In some exemplary embodiments, a planar, transparent covering may be coupled to and disposed forwardly of bars 904, 906.

Each post 902 can have a pair of mounting structures 908 coupled thereto, detail views of which are shown in FIGS. 10a-10c. Mounting structures 908 may be positioned along the vertical length of post 902 at known standard locations for mounting a fixed load backrest on a lift truck. In some exemplary embodiments, mounting structures 908 may be disposed within post 902 and coupled thereto. In other exemplary embodiments, mounting structures 908 may be disposed outside of post 902 and coupled thereto.

Each mounting structure 908 can include cylinders 910 for receiving fasteners, such as bolts, that facilitate coupling between the lift truck and the load backrest 900. Cylinders 910 may be oriented so as to engage corresponding coupling structures of the lift truck, for example standard coupling structures for mounting a fixed load backrest. In some exemplary embodiments, cylinders 910 may be oriented parallel to the plane of load backrest 900. Cylinders 910 can be disposed in corresponding elongated slots 912, which can be defined in the sides of post 902 and can extend horizontally between a front location and a rear location. Cylinders 910 may be horizontally movable within slots 912. Cylinders 910 can further extend into a hollow cavity 914 defined in mounting structure 908, and may be coupled to a plate 916 disposed in the cavity 914. Plate 916 may be movable within cavity 914 and may be engaged by a resilient member, such as a spring 918, disposed between plate 916 and a front wall of cavity 914. Plate 916 may further be supported by guides 920.

When spring 918 is in the extended position, plate 916 and cylinder 910 may positioned at the rearward location, as shown in FIG. 10a. When a force is applied to backrest 900, the force can move backrest 900 rearward with respect to the lift truck while cylinder 910 and plate 916 are maintained in place due to being coupled to a fixed part of the carriage assembly of the lift truck. The force results in spring 918 being compressed due to the displacement of plate 916 in relation to backrest 900, as shown in FIG. 10b. Thus, the movement and the dampening action of backrest 900 can result in the mitigation of impact to a load being placed onto the lift truck 10, and thus a mitigation of the damage to the load.

The embodiments of movable load backrests described herein can thus minimize damage to products that results from impact with the forks or the backrest of a lift truck. The movable load backrests can provide large surfaces, and/or spring-dampened front-rear movement with respect to the lift truck, both of which can mitigate the impact force felt by a load of a lift truck. Furthermore, transparent portions of the load backrests can provide visibility to the operator of the lift truck when the movable load backrest is mounted in a high position.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A movable load backrest for a lift truck, comprising:
at least one impact portion; and
at least one mounting structure coupled to the at least one impact portion and attachable to the lift truck;
wherein, when the movable load backrest is coupled to the lift truck, the distance between the at least one impact portion and the lift truck is variable.

2. The movable load backrest of claim 1, wherein the at least one impact portion is substantially planar.

3. The movable load backrest of claim 1, wherein the at least one impact portion comprises a transparent portion.

4. The movable load backrest of claim 1, wherein the at least one impact portion comprises a first impact portion and a second impact portion disposed in sliding relation.

5. The movable load backrest of claim 4, wherein the second impact portion is disposed rearwardly of the first impact portion.

6. The movable load backrest of claim 1, wherein the at least one impact portion comprises a frame having an opening defined therein, the frame being coupleable to the at least one mounting structure.

7. The movable load backrest of claim 1, wherein the at least one impact portion comprises:
a substantially planar portion; and
at least one rail coupled to the planar portion and coupleable to the at least one mounting structure.

8. The movable load backrest of claim 7, wherein the rail is fixedly coupled to a first mounting structure and slidably engaged with a second mounting structure.

9. The movable load backrest of claim 1, wherein the mounting structure comprises:
a first mounting member coupleable to the lift truck;
a second mounting member coupleable to the impact portion and disposed in sliding relation to the first mounting member; and
a resilient member engaged with the first mounting member and the second mounting member.

10. The movable load backrest of claim 9, wherein:
the first mounting member includes a channel defined therein; and
the second mounting member is receivable within the channel.

11. The movable load backrest of claim 1, wherein the mounting structure is fixedly coupled to the impact portion.

12. The movable load backrest of claim 1, wherein the mounting structure is slidably engaged with the impact portion.

13. A movable load backrest for a lift truck, comprising:
a first impact portion;
a second impact portion; and
at least two mounting structures coupled to each of the first impact portion and the second impact portion, the mounting structures being coupleable to the lift truck;
wherein, when the movable load backrest is coupled to the lift truck, the distance between the first impact portion and the lift truck is variable, and the distance between the second impact portion and the lift truck is variable.

14. The movable load backrest of claim 13, wherein first impact portion couples to a first pair of forks of the lift truck and the second impact portion couples to a second pair of forks of the lift truck.

15. The movable load backrest of claim 13, wherein each mounting structure comprises:
a first mounting member coupleable to the lift truck;
a second mounting member coupleable to the first impact portion or the second impact portion and disposed in sliding relation to the first mounting member; and
a resilient member engaged with the first mounting member and the second mounting member.

16. The movable load backrest of claim 13, wherein each of the first impact portion and the second impact portion comprises:
a substantially planar portion; and
at least one rail coupled to the planar portion and coupleable to a mounting structure.

17. The movable load backrest of claim 16, wherein the rail is fixedly coupled to a first mounting structure and slidably engaged with a second mounting structure.

18. The movable load backrest of claim 13, wherein the first impact portion and the second impact portion are disposed in sliding relation.

19. A movable load backrest for a lift truck, comprising:
at least one mounting means for mounting the movable load backrest on the lift truck;
at least one impact means for coming into contact with a portion of a load of the lift truck;
wherein the mounting means is adapted to vary the distance between the at least one impact means and the lift truck when the movable load backrest is coupled to the lift truck.

20. The movable load backrest of claim 19, wherein the at least one mounting means comprises dampening means.
